(19) United States
(12) Patent Application Publication
(10) Pub. No.: US 2026/0112255 A1
(43) Pub. Date: Apr. 23, 2026

(54) CONCEALED METAL DETECTION SYSTEM

(71) Applicant: Safe Space Ventures LLC, Grand Rapids, MI (US)

(72) Inventors: Jeremy Scott Knoester, Grand Rapids, MI (US); Sara Jean Knoester, Grand Rapids, MI (US)

(73) Assignee: Safe Space Ventures LLC, Grand Rapids, MI (US)

(21) Appl. No.: 18/920,407

(22) Filed: Oct. 18, 2024

Related U.S. Application Data
(60) Provisional application No. 63/545,226, filed on Oct. 23, 2023.

(51) Int. Cl. G08B 13/24; G01V 3/10

(52) U.S. Cl. CPC G08B 13/2494; G01V 3/108

(57) ABSTRACT

A detection system is provided for detecting entry of a target object into a protected area. The detection system includes a control unit and a search coil assembly comprising a plurality of search coil units in electronic communication with the control unit and extending continuously around a perimeter of the protected area to define a detection zone. The plurality of search coil units each comprise a transmitting coil and a receiving coil, wherein the transmitting coil is adapted to transmit an electromagnetic signal of a predetermined value, and the receiving coil is adapted to receive the electromagnetic signal, thereby generating an electromagnetic field. The control unit is configured to identify and initiate an emergency response condition in response to variations in the electromagnetic field corresponding to entry of the target object into the protected area via the detection zone.

### CROSS REFERENCE TO RELATED APPLICATIONS

This application claims the benefit of U.S. Provisional Application No. 63/545,226, filed Oct. 23, 2023, which is hereby incorporated by reference in its entirety.

### TECHNICAL FIELD

The subject innovation pertains to a system for forming a concealed detection zone around a perimeter of a protected area. More specifically, the innovation relates to a system that is configured to identify and distinguish entry of a target object into a protected area through a detection zone and initiate an emergency condition in response thereto.

### BACKGROUND

Metal detection systems for detecting metal objects are known in the art. Typical metal detection systems include a search coil extending around at least one discrete location of a building, such as a doorway or a corridor. However, metal detection systems known in the art are not configured or adapted to efficiently form a continuous metal detection zone around a large, protected area, such as the grounds of a school or an office building. Accordingly, the building or location may be left vulnerable if, for example, the traditional metal detection system is not installed at every point of entry into the building.

### SUMMARY

A concealed detection system for detecting entry of a target object into a protected area is provided herein. The detection system comprises a control unit and a search coil assembly in electronic communication with the control unit. The search coil assembly extends continuously around a perimeter of the protected area and is adapted to emit an electromagnetic field therefrom, thereby defining a detection zone. The control unit is configured to identify variations in the electromagnetic field corresponding to entry of the target object into the protected area via the detection zone. The control unit is further configured to initiate an emergency condition in response to a detected entry of the target object into the protected area via the detection zone.

According to another aspect of the innovation, utilizing the system of the present disclosure, a target object may be detected within the detection zone via the present method. The present method for detecting entry of a target object into the protected area includes steps of: generating an electromagnetic field with a search coil assembly, wherein the search coil assembly extends continuously around a perimeter of the protected area to define a detection zone; analyzing the electromagnetic field and detecting variations in the electromagnetic field that indicate an entry of the target object into the protected area via the control unit; and initiating an emergency condition via the control unit in response to the detected variation in the electromagnetic field.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

The embodiments set forth in the drawings are illustrative and exemplary in nature and not intended to limit the subject matter. The following detailed description of the illustrative embodiments can be better understood when read in connection with the following drawings, wherein like structures are indicated with like reference numerals and in which:

FIG. 1 is a fragmentary perspective view of a detection system for detecting entry of a target object into a protected area according to a first example embodiment of the present disclosure.

FIG. 2 is a fragmentary perspective view of a detection system for detecting entry of a target object into the protected area according to the first example embodiment of the present disclosure.

FIG. 3 is a fragmentary perspective view of a detection system for detecting entry of a target object into a protected area according to a second example embodiment of the present disclosure.

FIG. 4 is an enlarged fragmentary perspective view of one of a plurality of search coil units of the detection system of FIG. 1.

FIG. 5 is a fragmentary perspective view of the plurality of search coil units of the detection system of FIG. 1.

FIG. 6 is an enlarged perspective view of one of the plurality of search coil units of the detection system of FIG. 1 in an installed orientation showing a lid portion of the search coil unit.

FIG. 7 is an enlarged fragmentary perspective view of one of a plurality of search coil units of the detection system of FIG. 3.

FIG. 8 is a fragmentary perspective view of the plurality of search coil units of the detection system of FIG. 3.

FIG. 9 is a fragmentary perspective view of a detection system for detecting entry of a target object into a protected area according to a third example embodiment of the present disclosure.

FIG. 10 is a front view of an example control unit of the detection system of FIGS. 1, 3, and 9.

FIG. 11 is a flow chart detailing the steps of a method of detecting entry of a target object into a protected area utilizing the detection system of the present disclosure.

### DETAILED DESCRIPTION

While the present disclosure may be described with respect to specific applications or industries, those skilled in the art will recognize the broader applicability of the disclosure.

The terms “a”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of”the referenced claims.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

For consistency and convenience, directional adjectives are employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims. Any numerical designations, such as “first” or “second”are illustrative only and are not intended to limit the scope of the disclosure in any way.

The term “longitudinal”, as used throughout this detailed description and in the claims, refers to a direction extending a length of a component. The term “forward” or “anterior” is used to refer to the general direction from front to back of the respective component, and the term “rearward” or “posterior” is used to refer to the opposite direction. In some cases, a component may be identified with a longitudinal axis as well as a forward and rearward longitudinal direction along that axis. The longitudinal direction or axis may also be referred to as an anterior-posterior direction or axis.

The term “transverse”, as used throughout this detailed description and in the claims, refers to a direction extending a width of a component. The transverse direction or axis may also be referred to as a lateral direction or axis or a mediolateral direction or axis.

The term “vertical”, as used throughout this detailed description and in the claims, refers to a direction generally perpendicular to both the lateral and longitudinal directions. The term “upward” or “upwards” refers to the vertical direction pointing towards a top of the component. The term “downward” or “downwards” refers to the vertical direction pointing opposite the upwards direction, toward the bottom of a component. In addition, the term “proximal” refers to a direction that is nearer, and the term “distal” refers to a relative position that is further away. Thus, the terms proximal and distal may be understood to provide generally opposing terms to describe relative spatial positions.

Referring to the Figures, wherein like numerals indicate like or corresponding parts throughout the several views, a concealed detection system adapted for forming a discrete and continuous detection zone 12 around a perimeter P of a protected area 14, e.g., surrounding a building 16, such as a school, office, or the like, is shown generally at 10. In a general sense, the detection system 10 detects when a metal object enters the protected area 14.

The detection system 10 is further configured to identify and distinguish entry of predetermined target objects, such as weapons, ammunition, or other hazards comprised of metal, into the protected area 14 and initiate an emergency condition in response thereto, thereby allowing individuals and emergency responders both inside and outside the protected area 14 to take appropriate action to limit potential harm caused by one or more of the predetermined target objects or their custodian. More particularly, each example embodiment of the detection system 10 comprises a search coil assembly 20 further comprising a plurality of search coil units 22 adapted for placement around the perimeter P of the protected area 14, wherein each search coil unit comprises a transmitting coil 30a and a receiving coil 30b, and wherein the transmitting coil 30a is adapted to transmit an electromagnetic signal of a predetermined value and the receiving coil 30b is adapted to receive the electromagnetic signal, thereby generating an electromagnetic field.

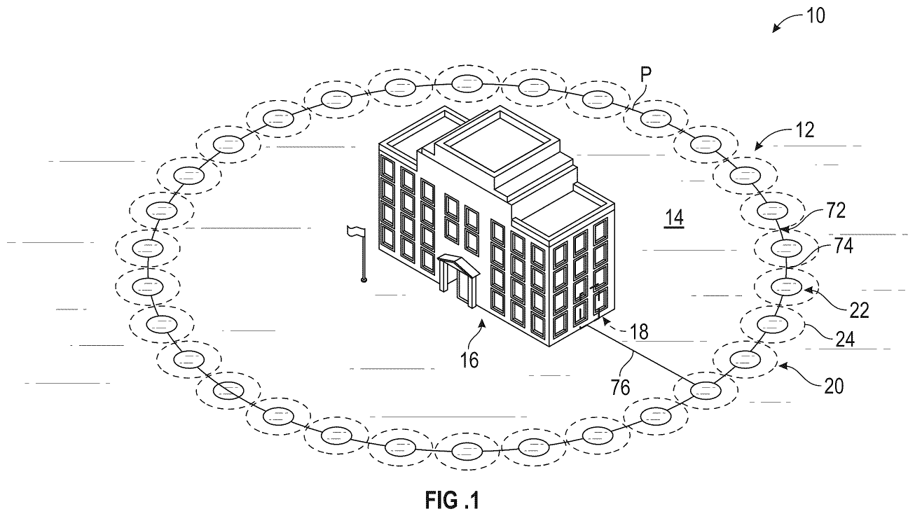

Referring to FIGS. 1-3, the detection system 10 generally includes a control unit 18 disposed at or within the perimeter P of the protected area 14 (e.g., within the building 16) and the search coil assembly 20 in electronic communication, either wired or wirelessly, therewith. The search coil assembly 20 extends continuously around the perimeter P of the protected area 14 and is adapted to emit the electromagnetic field susceptible to influence by an object comprised of metal. The electromagnetic field emitted by the search coil assembly 20 resultantly forms the detection zone 12 disposed between the building 16 and the perimeter P thereof.

The control unit 18 is configured to decipher changes in the electromagnetic field, which signals both the presence and type of metal objects entering the protected area 14 (e.g., one or more of the predetermined target objects), and selectively initiate the emergency condition in response to such changes in the electromagnetic field, as described in further detail below.

The search coil assembly 20 is adapted for placement either partially or fully in the ground such that the detection system 10 is partially hidden, fully hidden, or otherwise disguised from aboveground view but nonetheless capable of emitting the electromagnetic field a sufficient vertical distance to detect the presence and type of metal objects that enter the protected area 14 above the ground. For example, the detection system 10 is configured to detect when metal objects are carried or transported into the protected area 14 on a person or in their belongings. As such, the detection zone 12 extends fully around the perimeter P of the protected area 14 and a sufficient distance vertically therefrom (e.g., about two meters) for aboveground detection of metal objects and, more specifically, one or more of the predetermined target objects.

Generally, throughout the respective example embodiments of this disclosure, the search coil assembly 20 comprises the plurality of search coil units 22 adapted for placement around the perimeter P of the protected area 14 and in communication with the control unit 18. In each case, each of the respective search coil units 22 house the transmitting coil 30a and the receiving coil 30b, wherein the transmitting coil 30a is adapted to transmit the electromagnetic signal of the predetermined value and the receiving coil 30b is adapted to receive the electromagnetic signal, thereby generating the electromagnetic field.

Referring to FIGS. 1-3, the search coil assembly 20 comprises the plurality of search coil units 22. The search coil units 22 are configured for installation partially or fully into a substrate, such as the ground, around the perimeter P of the protected area 14 at predetermined intervals such that an individual metal detection field 24 of each of the plurality of search coil units 22 overlaps that of directly adjacent search coil units 22. As such, the plurality of search coil units 22 and the corresponding individual metal detection fields 24 form the detection zone 12 extending continuously around the perimeter P of the protected area 14.

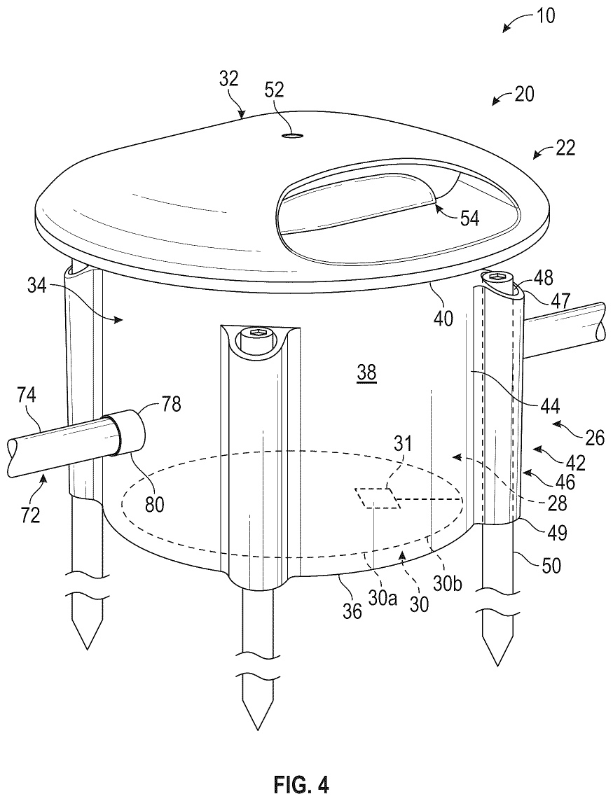

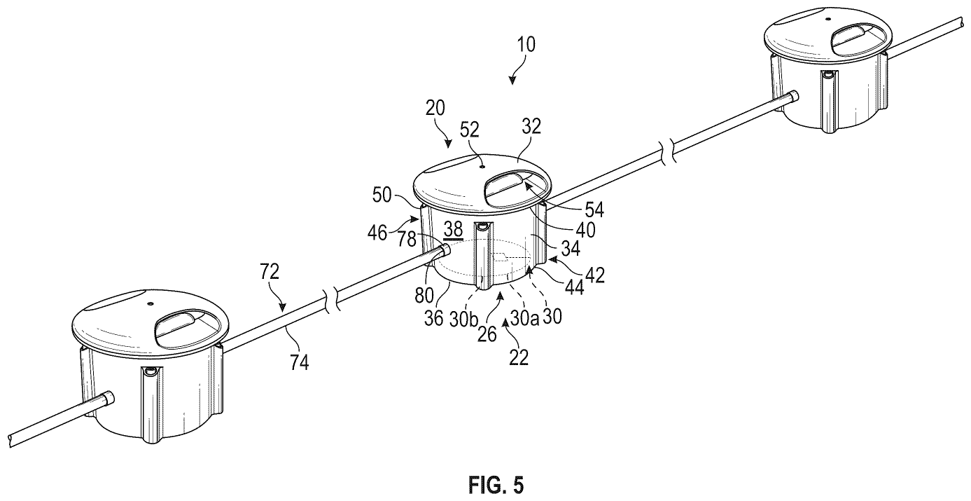

Referring to FIGS. 4-5 and 7-8, each of the plurality of search coil units 22 comprises a search coil housing 26 defining an interior space 28 and a plurality of internal electronic components 30 enclosed therein, wherein the plurality of electronic components 30 comprise at least the transmitting coil 30a, the receiving coil 30b, and a signal conditioning unit 31 in electronic communication with each other and the control unit 18. The transmitting coil 30a is configured to emit the electromagnetic signal of the predetermined value by sending pulsed electrical current therethrough, thereby generating the electromagnetic field via pulse induction around each of the plurality of search coil units 22. The receiving coil 30b is adapted to receive the electromagnetic signal from the transmitting coil 30a, and the signal conditioning unit 31 is configured to amplify, filter, and process the electromagnetic signal for transmission to the control unit 18. Accordingly, each of the plurality of search coil units 22 generates the individual metal detection field 24 therearound, as shown in FIGS. 1-3. It is contemplated that the transmitting coil 30a and the receiving coil 30b may be positioned in any suitable search coil configuration, including, by way of non-limiting example, a mono coil configuration (as shown in the figures), a concentric coil configuration, or a double-d (DD) coil configuration, without varying the scope of the invention.

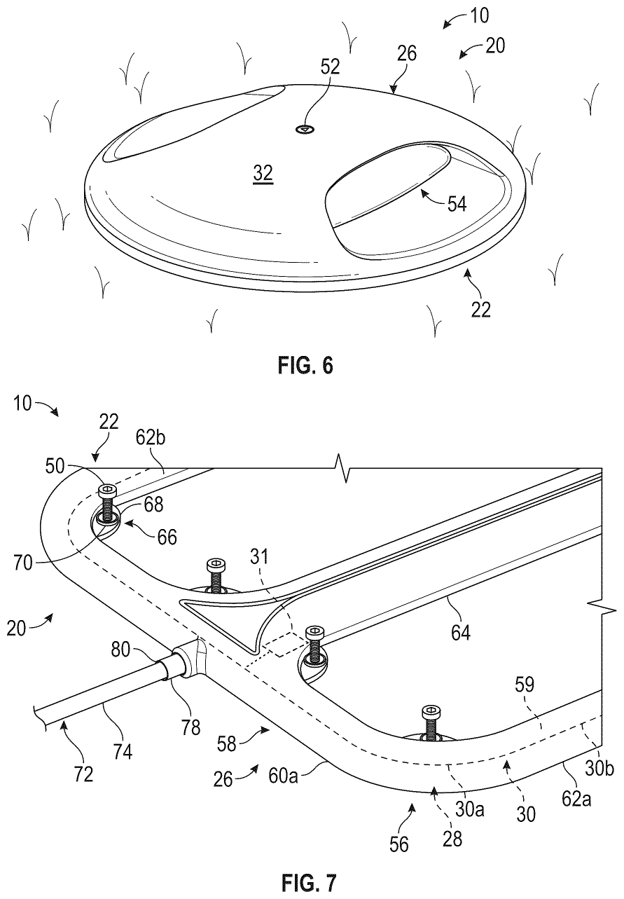

According to a first example embodiment of the detection system 10, as shown in FIGS. 1, 2, and 4-6, the search coil housing 26 comprises a lid portion 32 releasably affixed to a container portion 34. The container portion 34 is adapted for fixation to or placement within a substrate, such as in the ground, and the lid portion 32 is adapted to be positioned generally level with the ground such that only the lid portions 32 of the plurality of search coil units 22 are visible above the ground around the perimeter P of the protected area 14, as shown in FIG. 6.

The container portion 34 comprises a generally planar base 36 with at least one lateral wall 38 extending vertically therefrom and therearound. The lateral wall 38 further defines a top surface. As shown in FIG. 4, the planar base 36 and the lateral wall 38 cooperate to define the interior space 28 for containing the plurality of electronic components 30. The lid portion 32 is releasably coupled to the top surface of the lateral wall 38 via an upper lip 40, such that the lid portion 32 cooperates with the planar base 36 and the lateral wall 38 to enclose the plurality of electronic components 30 and seal the interior space 28 from exterior contaminants, such as water and soil. For example, the lip 40 may extend from the lid portion 32 and comprise a plurality of helical grooves configured to engage a plurality of corresponding helical ridges disposed on the top surface of the lateral wall 38 of the container portion 34, thereby reversibly enclosing and sealing the interior space 28 when the lid portion 32 is rotated onto the container portion 34.

Referring to FIG. 4, the container portion 34 further comprises a plurality of container securing elements 42 for securing the respective search coil units 22 of the first example embodiment to or into the substrate, such as the ground around the perimeter P of the protected area 14. Each of the securing elements 42 may comprise a protrusion having a protrusion body 46 extending from a first end 47 to a second end 49. The protrusion body 46 may extend outwardly from an outer face 44 of the lateral wall 38 and be formed integrally therewith. The protrusion body 46 may further define a tunnel 48 between the protrusion body 46 and the outer face 44 of the lateral wall 38, such that the tunnel 48 extends from the first end 47 to the second end 49 of the protrusion body 46.

Referring again to FIG. 4, the securing element 42 may further comprise an anchoring element 50. In this way, the anchoring element 50 is configured to be received by and extend through the tunnel 48 defined by the respective protrusion body 46 and into the substrate (e.g., ground) to secure the container portion 34 to the substrate. The anchoring element 50 may be further defined as a stake, a spike, a screw, or a similar fastening device suitable for insertion into the substrate into which the search coil units 22 are designed to be selectively fixed or anchored.

Referring to FIGS. 4-6, the lid portion 32 comprises a locking mechanism 52, such as a cam lock or tamper-resistant screw, configured for selectively securing and locking the lid portion 32 to the top surface of the lateral wall 38 of the container portion 34, thereby preventing unauthorized access to and potential tampering with the plurality of electronic components 30 of each search coil unit 22.

The lid portion 32 may further comprise a lighting element 54, such as, in one non-limiting example, an inset or recessed LED module, as shown in FIG. 4. The lighting element 54 may be configured such that each of the plurality of search coil units 22 resembles a decorative outdoor spotlight or landscaping light when installed around the perimeter P of the protected area 14, thereby further disguising the detection system 10. The lighting element 54 may be further configured to be in electronic communication with the control unit 18 and actuate a visual warning (e.g., changing the LED module from white to red or strobing of the LED module) in response to initiation of the emergency condition, detailed hereinbelow, thereby alerting individuals and emergency responders outside the protected area 14 to take appropriate action to limit potential harm caused by one or more of the predetermined target objects or their custodian.

Each search coil unit 22 of the search coil assembly 24 may further comprise a search coil audio indicator disposed within the interior space 28 defined by the housing 26. The search coil audio indicator may be in electronic communication with the control unit 18 and configured to emit an audible warning, such as a siren or a pre-programmed voice message, in response to initiation of the emergency condition, detailed hereinbelow, thereby alerting individuals and emergency responders outside the protected area 14 to take appropriate action to limit potential harm caused by one or more of the predetermined target objects or their custodian and/or simultaneously deterring the custodian of the target object from further approaching the protected area 14.

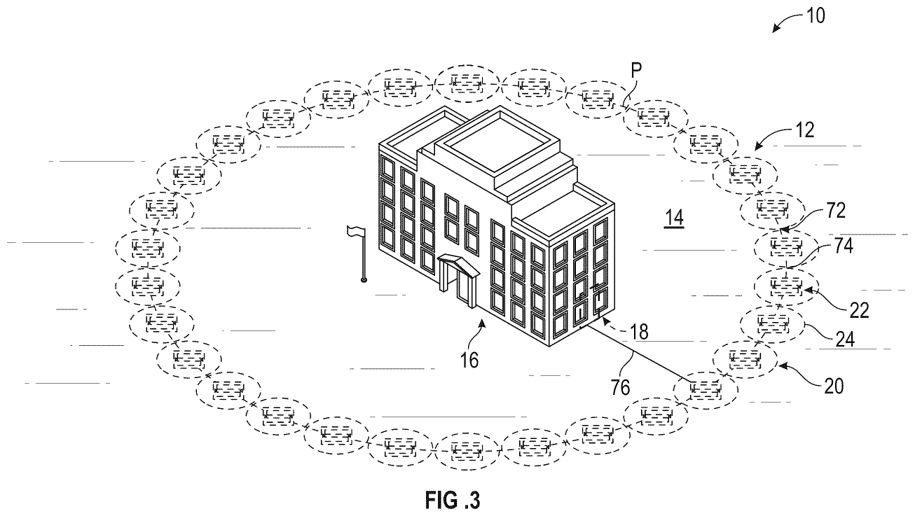

According to a second example embodiment of the detection system 10, as shown in FIGS. 3 and 7-8, the search coil housing 26 comprises a search coil frame 56 defined by a plurality of elongated members 58, wherein the search coil frame 56 is adapted for placement fully within and under the substrate, e.g., the ground, such that the plurality of search coil units 22 are fully hidden from aboveground view. Each of the plurality of elongated members 58 defines an interior cavity 59 to collectively form the interior space 28 for containing the plurality of electronic components 30.

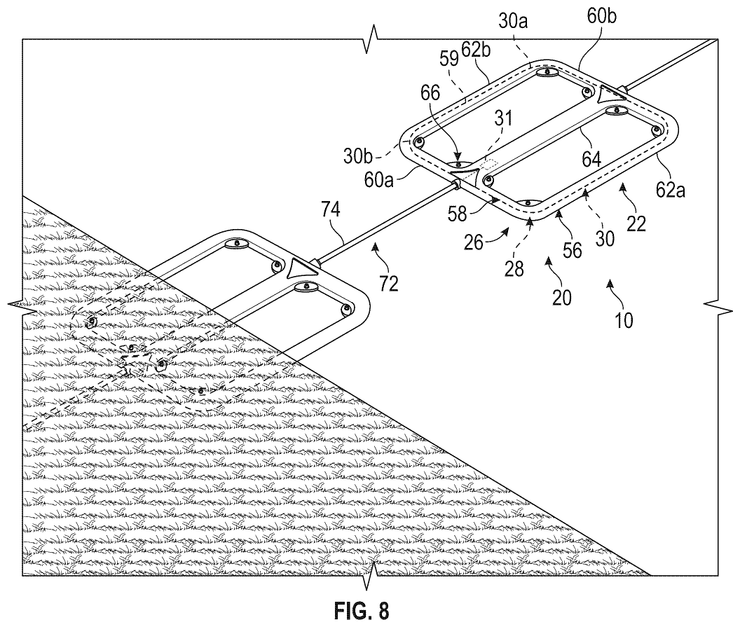

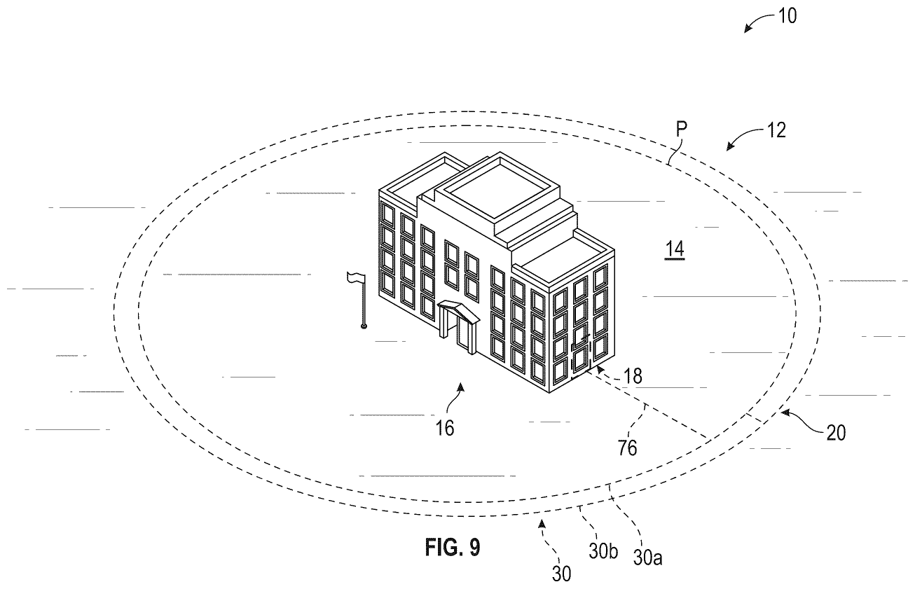

Referring to FIG. 8, the plurality of elongated members 58 comprises a pair of opposing lateral members 60a, 60b extending between a pair of opposing longitudinal members 62a, 62b, such that the transmitting coil 30a and the receiving coil 30b of the plurality of electronic components 30 may each extend around the entirety of the search coil frame 56 within the interior space 28. The plurality of elongated members 58 may further comprise an intermediate member 64 extending between the pair of lateral members 60a, 60b parallel to and spaced apart from, and in one non-limiting example, generally equidistant between the pair of longitudinal members 62a, 62b to provide additional structural support to the search coil frame 56. In another nonlimiting example, the transmitting coil 30a and the receiving coil 30b of the plurality of electronic components 30 may each extend through the interior cavity 59 of the intermediate member 64 from the first longitudinal member 62a to the second longitudinal member 62b.

The search coil frame 56 may further comprise a plurality of frame securing elements 66, as shown in FIG. 7, protruding from the plurality of elongated members 58 for securing the respective search coil units 22 in or to the substrate, e.g., in the ground around the perimeter P of the protected area 14. Each securing element 66 comprises a flange member 68, wherein the flange member 68 defines an aperture 70 adapted to receive and retain the anchoring element 50 to anchor the search coil frame 56 and, therefore, the respective search coil unit 22 to or within the substrate or ground.

Referring generally to the detection system 10, the plurality of search coil units 22 may be operatively coupled to the control unit 18 and each other via a wiring system 72 comprising a plurality of intermediate wires 74 and at least one control wire 76 for providing electronic and electrical communication between the plurality of search coil units 22 and the control unit 18, as shown in FIGS. 1 and 3. Referring to FIGS. 4-5 and 7-8, each intermediate wire 74 extends between adjacent search coil units 22, wherein the intermediate wire 74 enters the interior space 28 of the respective search coil units 22 via apertures 78 defined by the search coil housing 26 to operatively couple with the plurality of electronic components 30 (and, in the first example embodiment, the lighting element 54). A gasket 80 may be positioned within each aperture 78 to seal the interior space 28 from exterior contaminants entering via the aperture 78.

Referring again to FIGS. 1 and 3, the control wire 76 extends between at least one of the plurality of search coil units 22 and the control unit 18 for electronic and electrical communication between the control unit 18 and the plurality of search coil units 22. However, it is to be appreciated that the control wire 76 may alternatively extend between the control unit 18 and at least one of the intermediate wires 74, or, for example, a separate junction box in electronic and electrical communication with one or more of the search coil units 22, without varying the scope of the invention.

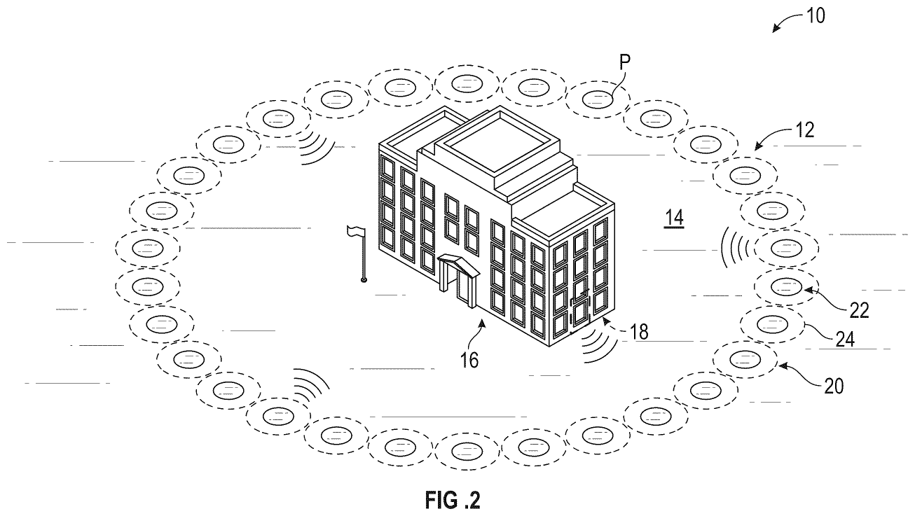

In the example embodiment of the detection system 10 shown in FIGS. 1 and 3, the wiring system 72 is configured to supply the plurality of search coil units 22 with electrical power sufficient to run the plurality of electronic components 30 (and, as applicable, the lighting element 54) and, additionally, provide electronic communication between the control unit 18 and the signal conditioning unit 31 of each search coil unit 22. However, it is to be appreciated that the wiring system 72 can instead supply the plurality of search coil units 22 with one of electrical power and electronic communication to and from the control unit 18, or be omitted entirely, as shown in FIG. 2, without varying the scope of the invention.

For example, if the wiring system 72 is not configured to supply the plurality of search coil units 22 with electrical power or is omitted entirely, it is appreciated that each search coil unit 22 may instead further comprise a battery assembly, such as a rechargeable lithium-ion battery and supporting electronics known in the art, in electrical communication with the plurality of electronic components 30 for supplying sufficient electrical power thereto. Or, if the wiring system 72 is not configured to transmit data to and from the control unit 18 or is omitted entirely, it is appreciated that each search coil unit 22 may instead further comprise a wireless communication module and antenna in electronic communication with the plurality of electronic components 30 to transmit data to and from the control unit 18 via short-range wireless technology (e.g., Bluetooth), wireless network protocols (e.g., wi-fi), or an RF module.

Alternatively, according to a third example embodiment of the detection system 10 shown in FIG. 9, the search coil assembly 20 may instead comprise a continuous outermost coil and a continuous innermost coil in electronic and electrical communication with the control unit 18, wherein the outermost coil and the innermost coil are buried coplanar in a concentric configuration underground around the perimeter P of the protected area 14. The outermost coil comprises one of the transmitting coil 30a and the receiving coil 30b, and the innermost coil comprises the other of the transmitting coil 30a and the receiving coil 30b, thereby generating the electromagnetic field and forming the detection zone 12.

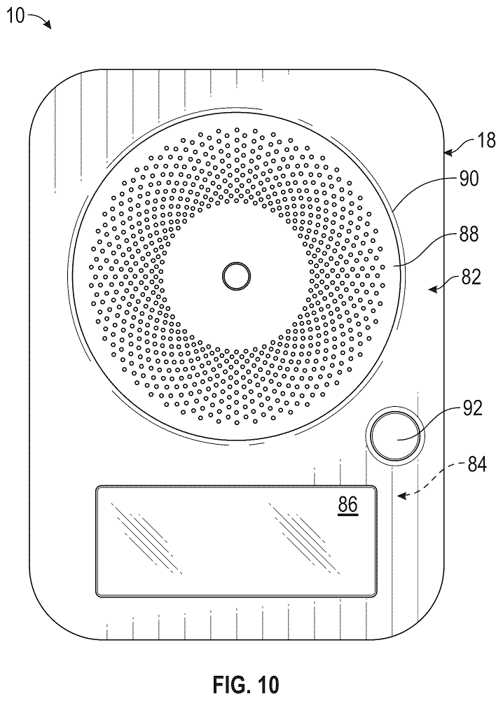

Referring generally to the detection system 10, the control unit 18 comprises a control unit housing 82 with at least one processor 84 enclosed therein, wherein the processor 84 is generally configured to receive, analyze, and decipher transmitted data from the plurality of search coil units 22 and facilitate initiation of the emergency condition in response to entry of one or more predetermined target objects into the protected area 14, as described in further detail below. Referring to FIG. 10, the control unit housing 18 comprises an integrated display 86, such as an LED display or capacitive touch screen, for viewing the status of the detection system 10, and a control unit audio indicator 88 configured to emit an audible warning, such as a siren or a pre-programmed voice message, in response to initiation of the emergency condition.

Referring again to FIG. 10, the control unit 18 may further include a lighting element 90 integrated within the control unit housing 82, such as an inset or recessed LED module, for actuating a visual warning to those in the vicinity of the control unit 18 in response to initiation of the emergency condition. At least one interface button or knob 92 may be operatively coupled with the control unit housing 82 for navigating a graphical user interface of the display 86 and operating the control unit 18. A battery backup system may further be integrated within the control unit housing 82 to ensure functionality of the detection system 10 during a loss of power to the control unit 18.

More particularly, the control unit 18 may include a non-transitory computer readable medium. The term non-transitory computer readable medium includes any medium that participates in providing data (e.g., instructions) and facilitating the transfer of code, which may be read by a computer. Such a medium may take many forms accessible by a computer, including, but not limited to, non-volatile media, volatile media, etc. Non-volatile media include, for example, optical or magnetic disks and other persistent memory. Volatile media include dynamic random-access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read, as well as networked versions of the same. The non-transitory computer readable medium stores or has written or embodied thereon a set of computer executable instructions that comprise the present method 100 detailed hereinbelow.

The control unit 18 may further comprise the at least one processor or signal processing unit 84 configured to execute the computer executable instructions embodied on the non-transitory computer readable medium. Computer-executable instructions may be compiled or interpreted from computer programs, software code, or algorithms created using a variety of programming languages and/or technologies, including, without limitation, and either alone or in combination, Java™, C, C++, Visual Basic, Java Script, Perl, html, etc. In general, a processor (e.g., a microprocessor) receives instructions, e.g., from a memory, a computer-readable medium, etc., and executes these instructions, thereby performing one or more processes, including one or more of the processes described within the present method. Such instructions and other data may be stored and transmitted using a variety of computer-readable media. It is appreciated that software modules can be callable from other modules or from themselves, and/or can be invoked in response to detected events or interrupts. The modules, computer executable instructions, and/or computing device functionality described herein are preferably implemented as software modules but can be represented in hardware or firmware. Generally, the modules, computer executable instructions, and/or computing device functionality described herein refer to logical modules that can be combined with other modules or divided into sub-modules despite their physical organization or storage.

It is contemplated that both the control unit 18 and the processor 84 may be automatically controlled by a computerized control strategy 100 written on memory of the control unit 18 and transmitted over a communications network. The processor 84 is programmed to monitor and detect changes in the electromagnetic field caused by the presence of metal objects within the detection zone 12. More specifically, the processor 84 automatically and continuously analyzes the electromagnetic signal transmitted by the signal conditioning unit 31 of each search coil unit 22, either via the wireless communication module and the antenna or via the wiring system 72, depending on the specific embodiment or implementation of the detection system 10, for detecting any variation of the electromagnetic signal from the predetermined value caused by the presence of metal within the detection zone 12.

When variation of the electromagnetic signal from the predetermined value is detected, the processor 84 may be further programmed to automatically determine the type of metal within the detection zone 12 by comparing the electromagnetic signal received by the receiving coil 30b and processed by the signal conditioning unit 31 to a set of known electromagnetic values corresponding to various types of metal objects written on the non-transitory computer readable medium in the form of a database or look-up table. If the electromagnetic signal corresponding to the metal object entering protected area 14 matches that of one or more target objects (for example, the steel of a firearm, knife blade, or arrow tip, or the brass, steel, nickel, and/or aluminum casing of ammunition) stored on the look-up table or within the database, the control unit 18 is configured to initiate the emergency condition. The processor 84 may additionally be programmed to automatically determine and indicate on the display 86 of the control unit 18 which of the plurality of search coil units 22 detected the variation of the electromagnetic signal, thereby assisting in determining where in the detection zone 12 the target object is located.

The emergency condition may include any of a number of subsequent actions initiated by the control unit 18 to limit potential harm caused by the target object. For example, among other possible actions, the control unit 18 may be configured to automatically actuate one or more of the following: an audible warning using the control unit audio indicator 88 integrated within the control unit housing 82; an audible warning using the search coil audio indicator disposed within each search coil housing 26 of the first example embodiment; an audible warning using an auxiliary, third-party alarm system located within the protected area 14; a visual warning using the lighting element 90 integrated within the control unit housing 82 (e.g., changing the color of the lighting element 90 from white to red or strobing of the lighting element); a visual warning using the lighting element 54 integrated within each search coil housing 26 of the first example embodiment (e.g., changing the color of the lighting element 54 from white to red or strobing of the lighting element); a visual warning using an auxiliary, third-party alarm system located within the protected area 14; a security lockdown, thereby preventing access to buildings 16 located within the protected area 14 by locking exterior doors and windows thereof; and a notification process to alert both individuals that occupy buildings 16 within the protected area 14 and emergency responders, such as local police. It is contemplated that the notification process may include sending push and SMS-based alerts via a wireless communications network to a pre-registered list of electronic devices, such as those corresponding to the individuals that occupy buildings 16 within the protected area 14 or their emergency contacts.

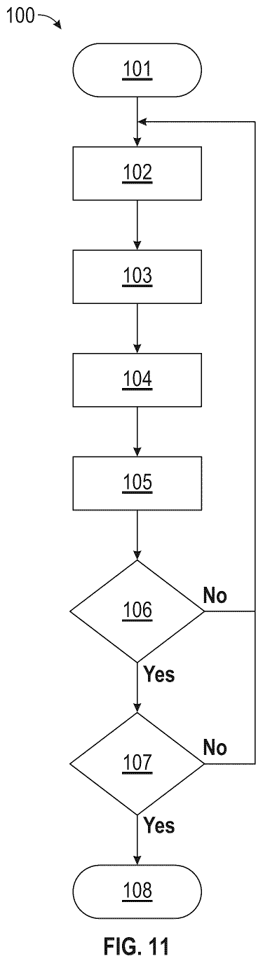

As detailed in the flow chart provided as FIG. 11, in operation, the detection system 10 may be utilized to identify and distinguish the presence of one or more target objects, such as a weapon, entering the protected area 14 through the detection zone 12 extending continuously around the perimeter P thereof. As such, the target object may be so detected, and the emergency condition initiated, according to the present method 100. Initially, at step 101, the detection system 10 may be armed via the control unit 18 and ready to detect and identify the presence of metal target objects entering the protected area 14 through the detection zone 12.

At step 102, the transmitting coil 30a of each respective search coil unit 22 emits the electromagnetic signal of the predetermined value, and, at step 103, the receiving coil 30b of the respective search coil unit 22 receives the electromagnetic signal from the transmitting coil 30a.

At step 104, the signal conditioning unit 31 of the respective search coil unit 22 amplifies, filters, and processes the electromagnetic signal and, at step 105, the signal conditioning unit 31 transmits the electromagnetic signal to the processor 84 of the control unit 18, either via the wireless communication module and the antenna or via the wiring system 72, depending on the specific embodiment or implementation of the detection system 10.

At step 106, the processor 84 automatically analyzes the electromagnetic signals received from the signal conditioning units 31 of each of the plurality of search coil units 22 to determine whether the electromagnetic signals received therefrom vary from the predetermined value. If the electromagnetic signals received by the wireless communication modules of the plurality of search coil units 22 do not vary from the predetermined value, thereby indicating that a metal object has not entered the protected area 14 through the detection zone 12, the process then returns to step 102 in which the transmitting coil 30a emits the electromagnetic signal of the predetermined value.

If, in step 106, the processor 84 determines that the electromagnetic signal received from any one of the signal conditioning units 31 of the plurality of search coil units 22 does vary from the predetermined value, thereby indicating that a metal object has entered the protected area 14 through the detection zone 12, then, in step 107, the processor 84 compares the electromagnetic signal to a look-up table of known electromagnetic values written on the memory of a signal processor, wherein the known electromagnetic values correspond to various types of metal objects.

If, in step 107, the electromagnetic signal corresponding to the metal object entering the protected area 14 through the detection zone 12 does not match that of one or more target objects, then the process returns to step 102 in which the transmitting coil 30a emits the electromagnetic signal of the predetermined value.

However, if, in step 107, the electromagnetic signal corresponding to the metal object entering protected area 14 through the detection zone 12 matches that of one or more target objects (for example, the steel of a firearm, knife blade, or arrow tip, or the brass, steel, nickel, and/or aluminum casing of ammunition), then, at step 108, the control unit 18 initiates the emergency condition.

While various embodiments have been described, the description is intended to be exemplary, rather than limiting and it will be apparent to those of ordinary skill in the art that many more embodiments and implementations are possible that are within the scope of the embodiments. While some of the best modes and other embodiments for carrying out the present teachings have been described in detail, various alternative designs and embodiments exist for practicing the present teachings defined in the appended claims. Any feature of any embodiment may be used in combination with or substituted for any other feature or element in any other embodiment unless specifically restricted. Accordingly, the embodiments are not to be restricted except in light of the attached claims and their equivalents. Many modifications and variations of the present invention are possible in light of the above teachings and within the scope of the attached claims. It is, therefore, to be understood that within the scope of the appended claims, the invention may be practiced other than as specifically described.

Benefits, other advantages, and solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claims.

What is claimed is:

1. A system for detecting entry of a target object into a protected area, the system comprising:
a search coil assembly configured to emit an electromagnetic field therefrom, the search coil assembly further comprising a plurality of search coil units extending continuously around a perimeter of the protected area to define a detection zone, each of the plurality of search coil units comprising a search coil housing defining an interior space and a plurality of electronic components disposed within the interior space, wherein the plurality of electronic components comprises a transmitting coil and a receiving coil such that the transmitting coil is adapted to transmit an electromagnetic signal of a predetermined value and the receiving coil is adapted to receive the electromagnetic signal, thereby generating the electromagnetic field;
a control unit comprising a signal processor controlled by a computerized control strategy written on a memory of the control unit and transmitted over a communications network, and wherein the control unit is in electronic communication with each of the transmitting coil and the receiving coil of each search coil unit, such that the signal processor is programmed to detect a variation of the electromagnetic signal received by the receiving coil of each search coil unit from the predetermined value transmitted by the respective transmitting coil of each search coil unit corresponding to an entry of the target object into the protected area via the detection zone; and
wherein the control unit is configured to initiate an emergency condition in response to the variation in the electromagnetic field corresponding to the entry of the target object into the protected area via the detection zone.

2. The system of claim 1 wherein the control unit is configured to actuate at least one of an audible alarm, a visual alarm, a security lockdown, and a notification process in response to an initiation of the emergency condition due to the variation in the electromagnetic field corresponding to the entry of the target object into the protected area via the detection zone.

3. The system in claim 2 wherein the control unit comprises a control unit housing enclosing the signal processor and including at least one of an LED display, an audio indicator, a lighting element, an interface button, and a battery backup system.

4. The system of claim 2 wherein the plurality of electronic components further comprises a signal conditioning unit in electronic communication with the transmitting coil and the receiving coil.

5. The system of claim 4 wherein the search coil housing of each search coil unit further comprises a search coil frame defined by a plurality of elongated members, and wherein each of the plurality of elongated members defines an interior cavity, such that the interior cavities defined by the plurality of elongated members collectively form the interior space.

6. The system of claim 5 wherein the plurality of elongated members further comprises:
a pair of opposing lateral members;
a pair of opposing longitudinal members extending between the opposing lateral members; and
an intermediate member extending from one of the lateral members to the other lateral member in a substantially parallel configuration with and spaced apart from each of the longitudinal members.

7. The system of claim 6 wherein the plurality of electrical components is disposed within the interior cavity collectively defined by the pair of opposing lateral members and the pair of opposing longitudinal members.

8. The system of claim 6 wherein the plurality of electrical components is disposed within the interior cavity defined by the intermediate member.

9. The system of claim 4 wherein the search coil housing of each search coil unit further comprises:
a container portion comprising a top surface, a bottom surface, and at least one sidewall; and
a lid portion disposed in contact with and releasably affixed to the top surface of the container portion;
wherein the interior space of the respective search coil housing is defined between the lid portion, the at least one sidewall, and the bottom surface of the respective container portion.

10. The system of claim 9 wherein the search coil housing of each search coil unit further defines an outer face disposed opposite the interior space; and
each search coil unit further comprises a securing element fixedly attached to the outer face of the search coil housing, the securing element adapted to secure the respective search coil unit at the perimeter of the protected area.

11. The system of claim 10 wherein the securing element further comprises a protrusion having a protrusion body integral with the outer face of the search coil housing and extending from a first end to a second end, wherein the protrusion body further defines a tunnel between the protrusion body and the outer face of the search coil housing, the tunnel extending from the first end of the protrusion body to the second end of the protrusion body.

12. The system of claim 11 wherein the securing element further comprises an anchoring element, wherein the anchoring element is configured to be received by and extend through the tunnel and into a substrate to secure the container portion to the substrate.

13. The system of claim 12 wherein the lid portion further comprises:
a locking mechanism configured for selectively fixing the lid portion to the top surface of the respective container portion; and
a lighting element in electronic communication with the control unit.

14. The system of claim 4 wherein:
the plurality of search coil units are disposed in electronic communication with the control unit via at least one of a wiring system, a short-range wireless technology, a wireless network protocol, and an RF module; and
the plurality of search coil units are powered by at least one of the wiring system and a battery assembly.

15. A method of detecting entry of a target object into a protected area, the method comprising:
generating an electromagnetic field with a search coil assembly, wherein the search coil assembly extends continuously around a perimeter of the protected area to define a detection zone;
analyzing the electromagnetic field via a control unit;
detecting variations in the electromagnetic field corresponding to entry of the target object into the protected area via the control unit; and
initiating an emergency condition in response to entry of the target object into the detection zone via the control unit.

16. The method of claim 15 wherein:
the search coil assembly comprises a plurality of search coil units adapted for placement around the perimeter of the protected area, each of the plurality of search coil units comprising a search coil housing defining an interior space and a plurality of electronic components disposed within the interior space and in electronic communication with the control unit, wherein the plurality of electronic components comprises a transmitting coil and a receiving coil;
the control unit comprises a signal processor controlled by a computerized control strategy written on a memory of the control unit and transmitted over a communications network, and wherein the control unit is in electronic communication with each of the transmitting coil and the receiving coil of each search coil unit, such that the signal processor is programmed to detect a variation of the electromagnetic signal corresponding to an entry of the target object into the protected area via the detection zone; and
the respective transmitting coil and the respective receiving coil of each of the search coil units is in electronic communication with the control unit via at least one of a wiring system, a short-range wireless technology, a wireless network protocol, and an RF module.

17. The method of claim 16 wherein the step of generating the electromagnetic field with the search coil assembly further comprises steps of:
transmitting an electromagnetic signal of a predetermined value from the transmitting coil of each search coil unit; and
receiving the electromagnetic signal with the receiving coil of the respective search coil unit.

18. The method of claim 17 wherein the step of analyzing the electromagnetic field via the control unit further comprises steps of analyzing the electromagnetic signal received by the receiving coil of each search coil unit via the signal processor of the control unit to determine whether the electromagnetic signal varies from the predetermined value transmitted by the respective transmitting coil of each search coil unit.

19. The method of claim 18 wherein the step of detecting variations in the electromagnetic field corresponding to entry of the target object into the protected area further comprises steps of:
comparing the electromagnetic signal received by each receiving coil to a known electromagnetic value corresponding to the target object via the signal processor; and
determining whether the electromagnetic signal received by each receiving coil matches the known electromagnetic value corresponding to the target object, thereby identifying entry of the target object into the protected area.

20. The method of claim 19 wherein the step of initiating the emergency condition in response to entry of the target object into the detection zone via the control unit further comprises steps of actuating at least one of an audible alarm, a visual alarm, a security lockdown, and a notification process.
